(19) United States
(12) Patent Application Publication
(10) Pub. No.: US 2026/0071156 A1
(43) Pub. Date: Mar. 12, 2026

(54) MICHELADA CONCENTRATE THAT WITHSTANDS FREEZING

(71) Applicant: José Yamil Esteban Higareda, Guadalajara (MX)

(72) Inventor: José Yamil Esteban Higareda, Guadalajara (MX)

(21) Appl. No.: 19/212,937

(22) Filed: May 20, 2025

(30) Foreign Application Priority Data
Sep. 12, 2024 (MX) MX/A/2024/011258

(51) Int. Cl. C12G 3/005; C12G 3/04

(52) U.S. Cl. CPC C12G 3/005; C12G 3/04

(57) ABSTRACT

The present invention relates to a concentrate of micheladas capable of resisting temperatures up to −12° C. degrees Celsius without reaching a state of solidification. This resistance comes from specific compounds to create the desired concentrate, considering that it will be inside freezing chambers which in turn will be inside independent ecological plastic containers which do not interfere with the composition of the formulations. The invention may or may not coexist with ice inside the aforementioned containers.

### FIELD

The following invention is within the field of consumable foods and beverages for humans, specifically in the concentrate of the ingredients for the preparation of a michelada. This field encompasses the development of a method that allows the concentrate to be kept liquid, which may, or may not, coexist with ice, for an indefinite time inside conventional freezing chambers that are at temperatures between −10° C. and −12° C. degrees without reaching a state of solidification so that it can be consumed completely cold without the need to wait for it to return to its liquid composition.

### RELATED APPLICATIONS

This application is a continuation of MX/a/2024/011258, filed Sep. 12, 2024. The entire contents of the above application are hereby incorporated by reference as though fully set forth herein.

### BACKGROUND

The need for human beings to combat hot summer days, areas and regions with high heat waves, as well as the taste for drinking cold drinks have led us to revolutionize the way drinks are taken. Whether ice is added to glasses, creating ice cream, milkshakes, as well as frappes and other frozen or semi-frozen sweetened beverages for human consumption, or, by the simple act of taking beverages directly from the cold rooms or putting them in the freezer so they can feel fresher, prior to freezing.

According to the patent registered under number JP2006048325A, all the processes that are carried out for the freezing of beverages have been inventive methods, in this case, by means of frozen beverage vending machines which maintain the freezing of the same for distribution and easy purchase by consumers. Similarly, there are machines created to dispense semi-frozen or slushied beverages for the consumption of customers who like this type of sensation as mentioned in the patent registered under number U.S. Pat. No. 3,995,770A.

Even prepared drinks and cocktails have been a great contribution to the experience of consuming beverages with or without liquor for consumers, taking different techniques to protect the cold temperature of the drinks with the use of ice, nitrogen, dry ice or other elements in order to provide a unique consumption experience to those who like completely cold drinks as can be seen in one of the Mexican patents under registration number MXPA97008526A.

It is worth mentioning that the fact of adding ice to drinks can be a factor that melts and changes the composition and even the flavor of the main drink. This is mentioned because the present invention does not seek to improve a flavor as the ice melts, as explained in the JPS60210969A patent, but seeks to keep the michelada concentrate in a liquid state either by adding ice, or not, and preventing it from freezing while it is inside a conventional freezing chamber.

It is important to mention that each of the beverages known as fresh water, salt water, alcohol, beer, oil, carbonated beverages, as well as any other type of liquid or beverage have a specific chemical composition that protects them, to a certain extent, from reaching the freezing point below 0° C., taking into consideration that this could affect their own composition, its taste, or simply its degeneration until it is not suitable for human consumption.

The present invention has been developed with the purpose of continuing with this evolution of giving the end consumer the experience of drinking beverages directly from conventional freezing chambers or introducing them into it so that it can take a cold sensation without the need to reach a solid state, as happens with any other beverage such as soft drinks, beer, water, prepared beverages and juices, to mention a few. The concentrate may or may not coexist with ice inside the chambers and this will not cause it to freeze but will continue in a liquid state ready for consumption.

There are other components to prevent the freezing of liquids that are inside the freezing chambers such as food-grade antifreeze, which within the beverage industry is used to cool and maintain low temperatures in beverages such as soft drinks, juices and/or beer which is mainly useful in dispensers or beverage vending machines.

It should be taken into consideration that the aforementioned ways of drinking a cold drink in this section deals with the modification and adhesion of components in order to create a drink that remains cold or frozen and can be consumed, or not, immediately by anyone. However, the fact that a liquid and ice, in this case, coexist within the same container, preventing the liquid from becoming a solid state when said container or container is inside a freezing chamber, there is no previous record or antecedent, to keep the concentrate without it freezing and the final consumer must wait for it to return to its liquid state to be able to ingest it.

Since the present invention refers primarily to the consumption of the concentrate of a michelada that does not freeze and remains liquid whether or not ice is added to it and is inside a freezing chamber, this invention will create a historical precedent for the consumption of cold drinks taken directly from a freezer to be a unique and unparalleled experience for when the consumer seeks to purchase their favorite beverage directly from the freezer without it changing its flavor and remaining liquid, preventing it from reaching the freezing point, giving a consumer the certainty that said preparation or drink was made with the best quality standards for human consumption.

### DESCRIPTION OF THE FIGURES

FIG. 1: The concentrate of the michelada fresh from the freezer is shown in liquid form which contains ice, showing that it is completely solid coexisting with the concentrate.

### DESCRIPTION OF THE INVENTION

The present invention arises thanks to the fact that beverages seek to be consumed in the most refreshing way possible, due to the existence of machines and processes that freeze carbonated, non-carbonated, alcoholic and non-alcoholic beverages and by those that dispense frozen, semi-frozen beverages known as slushies. However, the process of cooling the drinks, as well as adding ice to it tend to generate a change in the composition and flavor of them (not all, for example, water) that is why the present invention has the necessary methods not to vary the flavor of the drinks, mainly the concentrate of micheladas, and keep it in a liquid state while ice is added, or not, and it is inside a freezing chamber.

Let us remember that the main idea of the present invention, in addition to what was stated in the previous paragraph, is that when we seek to cool a drink as soon as possible we opt for the use of a freezer and if time passes without taking care of what we introduce, the introduced beverage tends to solidify (freeze) requiring a consumer to wait for said drink to return to its liquid state without mentioning that this could vary in flavor or composition of the drink introduced.

It is of utmost importance to mention that, although it may be possible to lower the freezing point of any beverage, by adding the necessary components, this new invention is considered an innovation since the michelada concentrate can be sold separately, that is, if it is sought to be cold, or not, prior to consumption it can be kept inside conventional freezing chambers without it reaching a solid state. Similarly, if you are looking to sell it as a drink prepared with ice, it will be sold inside a plastic container where the concentrate and ice can coexist and, at the same time, are inside a freezing chamber causing the same effect, preventing the freezing of the michelada concentrate.

The present invention is based on the evolution of the consumption of antifreeze drinks whether ice is added or not, in this case the michelada concentrate, which when introduced directly into the conventional freezer contains the perfect formulation so that the liquid does not freeze and resists temperatures up to −10° C. (minus ten degrees Celsius) taking into consideration that the concentrate and the ice can coexist within the same container or concentrate can be inside without any other component, achieving the same result, avoiding solidification.

The method used for this process to generate the correct consistency to prevent the michelada concentrate from freezing consists of the following components described in the following formulation (1):

Formulation 1

| | | Weight | | | MP | Price | Formula |
|---|---|---|---|---|---|---|---|
| Raw | | (Kg) | Yield | Yield | Requirement | per | Cost |
| material | % | LT | MP(%) | PT(%) | (Kg) | Kg | (kg) |
| Fructose | 44.480 | 444.800 | 100.000 | 100.000 | 444.800 | $25.50 | $11.342 |
| 42 | | | | | | | |
| PVH | 38.000 | 380.000 | 100.000 | | 380.000 | $180.50 | $68.590 |
| 448 | | | | | | | |
| liquid | | | | | | | |
| PVH | 11.000 | 110.000 | 100.000 | | 110.000 | $172.50 | $18.975 |
| 11318 | | | | | | | |
| Powder | | | | | | | |
| Guajillo | 3.000 | 30.000 | 100.000 | | 30.000 | $92.00 | $2.760 |
| Chile | | | | | | | |
| Lemon | 2.300 | 23.000 | 100.000 | | 23.000 | $160.00 | $3.680 |
| powder | | | | | | | |
| Citric | 1.200 | 12.000 | 100.000 | | 12.000 | $38.00 | $0.456 |
| acid | | | | | | | |
| Citrogen | 0.020 | 0.200 | 100.000 | | 0.200 | $590.00 | $0.118 |
| M | | | | | | | |
| Powder | | | | | | | |
| Total | 100.000 | 1000.000 | | | 1000.000 | | $105.921 |

The process that must be carried out consists of the incorporation of the ingredients described above, which must be weighed and carefully mixed to reach the expected result, which is to avoid freezing the concentrate. Fructose 42 must be added with a percentage of 44.48%, which is equivalent to 444.800 (kg); the liquid HPV 448, which serves as a flavor enhancer in base for soy sauces with a percentage of 38% that is equivalent to 380 (kg); PVH 11318 powder, which is a hydrolyzed soy protein that must be added with a percentage of 11%, which is equivalent to 110 (kg); guajillo pepper with a percentage of 3% that is equivalent to 30 (kg); lemon powder with a percentage of 2.3% that is equivalent to 23 (kg); citric acid with a percentage of 1.2%, which is equivalent to 12 (kg) and finally add citrogen M powder with a percentage of 0.020% equivalent to 0.200 (kg).

This last formulation described is if the mixture is sought with a total of 1,000 LT (one thousand liters). If it is intended to be made in different presentations, each of the ingredients must be added in proportion to the container or capacity to be produced.

After that, the concentrate must enter a pasteurization process in a stainless-steel container with constant agitation, either mechanical or manual, and must be raised to a temperature of 85° C.±2° C. degrees Celsius for five minutes and then recover the evaporated water with purified water. The evaporated water is recovered to obtain the same initial consistency and not vary the formulation by the amount of water that evaporates according to the equipment used, so it should be done with a small kettle and with a lid, since a larger and more open kettle will evaporate more water.

Finally, the packaging of the product must be in hermetically sealed containers, previously sanitized, where they must be packaged at a minimum temperature of 70° C. (seventy degrees Celsius) and their storage must be in a cool and dry place between 20° C. (twenty degrees) and 25° C. (twenty-five degrees) Celsius.

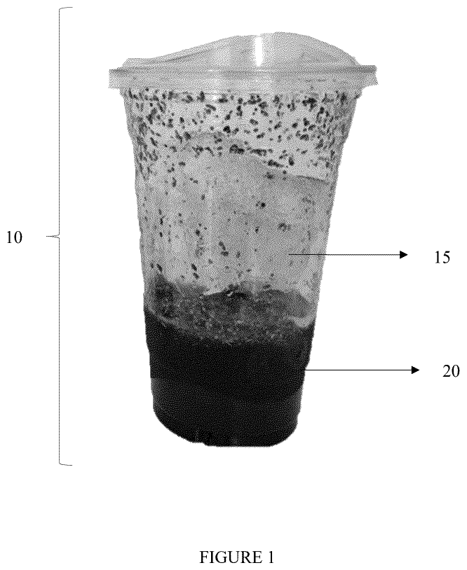

FIG. 1 shows the concentrate 20 in a container 10 with ice 15 that is ready for consumption. As discussed above, ice 15 is not required to keep the concentrate 20 in a liquid state.

In an alternative embodiment, the invention can be created without using the material “PVH 448”, resulting in the same consistency and use, which is to avoid freezing when entered into conventional freezing chambers, provided that the ranges and percentages of weights used to arrive at the final result are used according to the following formulation (2):

Formulation 2

| | | Weight | | | MP | Price | Formula |
|---|---|---|---|---|---|---|---|
| Raw | | (Kg) | Yield | Yield | Requirement | per | Cost |
| material | % | LT | MP(%) | PT(%) | (Kg) | Kg | (kg) |
| Fructose | 45.480 | 454.800 | 100.000 | 100.000 | 454.800 | $25.50 | $11.597 |
| 42 | | | | | | | |
| Purified | 28.000 | 280.000 | 100.000 | | 280.000 | $0.03 | $0.008 |
| Water | | | | | | | |
| PVH | 20.000 | 200.000 | 100.000 | | 200.000 | $172.50 | $34.500 |
| 11318 | | | | | | | |
| Powder | | | | | | | |
| Guajillo | 3.000 | 30.000 | 100.000 | | 30.000 | $92.00 | $2.760 |
| Chile | | | | | | | |
| Lemon | 2.300 | 23.000 | 100.000 | | 23.000 | $160.00 | $3.680 |
| powder | | | | | | | |
| Citric | 1.200 | 12.000 | 100.000 | | 12.000 | $38.00 | $0.456 |
| acid | | | | | | | |
| Citrogen | 0.020 | 0.200 | 100.000 | | 0.200 | $590.00 | $0.118 |
| M | | | | | | | |
| Powder | | | | | | | |
| Total | 100.000 | 1000.000 | | | 1000.000 | | $53.120 |

The process that must be carried out consists of the integration of the ingredients described above, which must be weighed and carefully mixed to reach the expected result, which is to avoid freezing the concentrate. Fructose 42 must be added with a percentage of 45.480% which is equivalent to 454.800 (kg); add purified water with a percentage of 28% equivalent to 280 (kg); HPV 11318 powder, which is a hydrolyzed soy protein that must be added with a percentage of 20% equivalent to 200 (kg); add guajillo pepper with a percentage of 3% that is equivalent to 30 (kg); add lemon powder with a percentage of 2.3%, which is equivalent to 23 (kg); add citric acid with a percentage of 1.2% that is equivalent to 12 (kg) and finally add citrogen M powder with a percentage of 0.020% which is equivalent to 0.200 (kg).

This last formulation described is if the mixture is sought with a total of 1,000 LT (one thousand liters). If it is intended to be made in different presentations, each of the ingredients must be added in proportion to the container or capacity to be produced.

After that, the concentrate must enter a pasteurization process in a stainless steel container with constant agitation, either mechanical or manual, and must be raised to a temperature of 85° C.±2° C. degrees Celsius for five minutes and then recover the evaporated water with purified water. The evaporated water is recovered to obtain the same initial consistency and not vary the formulation by the amount of water that evaporates according to the equipment used, so it should be done with a small kettle and with a lid, since a larger and more open kettle will evaporate more water.

Finally, the packaging of the product must be in hermetically sealed containers, previously sanitized, where they must be packaged at a minimum temperature of 70° C. (seventy degrees Celsius) and their storage must be in a cool and dry place between 20° C. (twenty degrees) and 25° C. (twenty-five degrees) Celsius.

Once the concentrate is ready, either according to formulation (1) or formulation (2), it can be packaged together with the ice, or not, inside a plastic container for transport to the conventional freezing chambers that are between −10° C. and −12° C. degrees Celsius.

It is important to mention that the concentrate may or may not have ice for consumption, the invention once created can be introduced with or without ice to the freezing chambers where it can be observed that with the passage of time inside the chamber it will not vary its consistency, that is, it will not enter a solid state, but it will stay fresh and ready to be consumed. In the event that the concentrate and the ice coexist within a container and are introduced into the freezing chamber, the same result will be observed, that is, a liquid state of the invention to be consumed immediately without having to wait for it to return to its liquid state.

In case the second method mentioned above is used, that is, with the use of ice and concentrate that coexist in the same container and is introduced into a freezing chamber, the following percentages must be observed to keep the concentrate in its liquid state, it is worth mentioning that the variation of the ice cubes in their percentage will not affect the composition of the concentrate, adding more percentage of the concentrate will affect since it will continue to remain liquid inside the freezing chambers, only reference is made to the preference in how the invention in question should be consumed.

| Ingredients | % | Weight (g) |
|---|---|---|
| Ice cubes | 18.9 | 100 |
| Michelada concentrate | 14.2 | 75 |
| Beer or beverage of choice | 67 | 355 |
| (personal addition) | | |

On the other hand, the beer or beverage of the consumer's preference will be added at the choice of each one, but it does not influence as an ingredient for the concentrate to remain liquid inside the freezing chamber. This complement is added once the consumer acquires the product and, in this way, can enjoy their drink without the need to wait for it to thaw.

The present invention seeks to be a precedent for the consumption of cold beverages taken directly from the freezer without losing their liquid consistency, which, although it has been mentioned that there are various machines that produce semi-frozen or slushied beverages, the idea of creating a concentrate that does not solidify inside refrigeration chambers or conventional freezers has not been disclosed. The formulation of the disclosed concentrate is designed to prevent it from freezing inside refrigeration chambers or those operating within a temperature range of −10° C. to −12° C., but not under strict freezing conditions. If temperatures drop below −12° C., this may cause the concentrate to solidify, making it unsuitable for immediate consumption by the end customer.

The invention goes beyond the protection of the michelada concentrate disclosed in the preferred embodiments. Rather, the aspect of the invention centers around the opening and evolution for the consumption of antifreeze drinks directly taken from conventional freezing chambers so that they continue in a liquid state without solidifying, which generates a new experience for the consumer, who should not wait for said drink and/or concentrate to thaw. On the contrary, the consumer will have a liquid drink that coexists with totally refreshing ice, or not, to be ingested immediately.

What is claimed is:

1. A method comprising the steps of:
providing a compound for a concentrate comprising: Fructose, liquid HPV, HPV 11318 liquid, HPV 11318 powder, guajillo pepper, lemon powder, citric acid, and citrogen M powder.

2. The method of claim 1 further comprising the step of pasteurizing the compound inside a stainless steel container with constant agitation.

3. The method of claim 2 further comprising the step of raising the temperature of the compound to an approximate temperature of 85° C.

4. The method of claim 3 further comprising the step of adding purified water to the compound.

5. The method of claim 4 further comprising the step of packaging the compound in a hermetically sealed container at a minimum temperature of 70° C.

6. The method of claim 5 further comprising the step of storing compound at a temperature ranging from 20° C. to 25° C.

7. The method of claim 6 further comprising the step of placing the compound in a heat-sealed container;

8. The method of claim 7 further comprising the step of storing the heat-sealed container in a freezing chamber operable to store the compound at a temperature not lower than −12° C. degrees Celsius.

9. The method of claim 1 wherein the compound is based on the following: 44.48% Fructose 42; 38% liquid HPV 448; 11% HPV 11318 powder; 3% guajillo pepper; 2.3% lemon powder; 1.2% citric acid; and 0.020% citrogen M powder.

10. A method comprising the steps of:
providing a compound for a concentrate comprising Fructose, purified water, HPV 11318 powder, guajillo pepper, lemon powder, citric acid, and citrogen M powder.

11. The method of claim 10 further comprising the step of pasteurizing the compound inside a stainless steel container with constant agitation.

12. The method of claim 11 further comprising the step of raising the temperature of the compound to a temperature of approximately 85° C.

13. The method of claim 12 further comprising the step of adding purified water.

14. The method of claim 13 further comprising the step of packaging the compound in a hermetically sealed container at a minimum temperature of 70° C.

15. The method of claim 14 further comprising the step of storing the compound at a temperature ranging from 20° C. to 25° C.

16. The method of claim 15 further comprising the step of placing the compound in a heat-sealed container.

17. The method of claim 16 further comprising the step of storing the heat-sealed container in a freezing chamber operable to store the compound at a temperature not less than −12° C. degrees Celsius.

18. The method of claim 10, wherein the concentrate is based on the following: 44.48% Fructose 42; 28% purified water; 20% HPV 11318 powder; 3% guajillo pepper; 2.3% lemon powder; 1.2% citric acid; and 0.020% citrogen M powder.

19. A michelada concentrate compound comprising a combination of Fructose, liquid HPV 448, HPV 11318 powder, guajillo pepper, lemon powder, citric acid, and citrogen M powder, wherein the compound remains in liquid form at temperatures warmer than −12° C.

20. The michelada concentrate composition of claim 19 wherein the compound is based on the following: 44.48% Fructose 42; 38% liquid HPV 448; 11% HPV 11318 powder; 3% guajillo pepper, 2.3% lemon powder; 1.2% citric acid; and 0.020% citrogen M powder.
